(19) United States
(12) Patent Application Publication
(10) Pub. No.: US 2021/0068101 A1
(43) Pub. Date: Mar. 4, 2021

(54) SYNCHRONIZATION SIGNAL BLOCK AND PHYSICAL CHANNEL STRUCTURE FOR SIDELINK COMMUNICATIONS

(71) Applicant: MediaTek Singapore Pte. Ltd., Solaris (SG)

(72) Inventor: Tao CHEN, Beijing (CN)

(73) Assignee: MediaTek Singapore Pte. Ltd., Solaris (SG)

(21) Appl. No.: 17/001,039

(22) Filed: Aug. 24, 2020

Related U.S. Application Data
(63) Continuation of application No. PCT/CN2019/103273, filed on Aug. 29, 2019.

(30) Foreign Application Priority Data
Aug. 18, 2020 (CN) 202010831240.1

(51) Int. Cl. H04W 72/04; H04L 1/00; H04W 56/00; H04W 72/00

(52) U.S. Cl. CPC H04W 72/0413; H04L 1/0057; H04W 72/005; H04W 56/001; H04W 72/044

(57) ABSTRACT

A method of sidelink transmission with two-stage sidelink control information (SCI) can include transmitting a physical sidelink control channel (PSCCH) including a 1st-stage sidelink control information (SCI) over a sidelink from a transmission user equipment (Tx UE) to a reception user equipment (Rx UE), and transmitting a physical sidelink shared channel (PSSCH) that is associated with the PSCCH and includes a 2nd-stage SCI encoded by polar code having cyclic redundancy check (CRC) bits. In an embodiment, the 1st-stage SCI of the PSCCH indicates whether the 2nd-stage SCI of the PSSCH has the CRC bits scrambled with bits of a physical layer identity (L1-ID).

### INCORPORATION BY REFERENCE

This present application claims the benefit of Chinese Patent application No. 202010831240.1, “Synchronization Signal Block and Physical Channel Structure for Sidelink Communications” filed on Aug. 18, 2020, which claims benefit of International Patent Application No. PCT/CN2019/103273, “Synchronization and Physical Channel Structure for V2X SL Communications” filed on Aug. 29, 2019. The prior applications are incorporated herein by reference in their entirety.

### TECHNICAL FIELD

The present disclosure relates to wireless communications, and specifically relates to sidelink communications.

### BACKGROUND

Cellular based vehicle-to-everything (V2X) (e.g., LTE V2X or NR V2X) is a radio access technology developed by the 3rd Generation Partnership Project (3GPP) to support advanced vehicular applications. In V2X, a direct radio link (referred to as a sidelink) can be established between two vehicles. The sidelink can operate under the control of a cellular system (e.g., radio resource allocation being controlled by a base station) when the vehicles are within the coverage of the cellular system. Or, the sidelink can operate independently when no cellular system is present.

### SUMMARY

Aspects of the disclosure provide a method of sidelink transmission with two-stage sidelink control information (SCI). The method can include transmitting a physical sidelink control channel (PSCCH) including a 1st-stage sidelink control information (SCI) over a sidelink from a transmission user equipment (Tx UE) to a reception user equipment (Rx UE), and transmitting a physical sidelink shared channel (PSSCH) that is associated with the PSCCH and includes a 2nd-stage SCI encoded by polar code having cyclic redundancy check (CRC) bits. In an embodiment, the 1st-stage SCI of the PSCCH indicates whether the 2nd-stage SCI of the PSSCH has the CRC bits scrambled with bits of a physical layer identity (L1-ID).

In an example, the second PSSCH including the 2nd-stage SCI that has a payload including the L1-ID is transmitted when the 1st-stage SCI of the PSCCH indicates no CRC bits of the 2nd-stage SCI of the PSSCH are scrambled with the bits of the L1-ID.

In an embodiment, a configuration is received indicating whether to carry information of the L1-ID by scrambling the CRC bits of the 2nd-stage SCI with the bits of the L1-ID. In an embodiment, the L1-ID is a source ID or a destination ID corresponding to the transmission of the PSCCH and the PSSCH. In an embodiment, a part of the L1-ID is carried in a payload of the 2nd-stage SCI of the PSSCH. In an embodiment, the PSCCH is mapped to physical resources in one subchannel, and the PSSCH is mapped to physical resources in one or more subchannels.

An embodiment of the disclosure can further include transmitting a sidelink synchronization signal block (S-SSB) in a slot, where the S-SSB includes two consecutive sidelink primary synchronization signal (S-PSS) symbols at the end of the S-SSB followed by one or more guard period (GP) symbols in the slot. In an embodiment, the S-SSB includes two sidelink secondary synchronization signal (S-SSS) symbols arranged ahead of the two consecutive S-PSS symbols with zero, one, or more than one physical sidelink broadcast channel (PSBCH) symbols between the two S-SSS symbols and the two consecutive S-PSS symbols.

Aspects of the disclosure provide an apparatus comprising circuitry. The circuitry can be configured to transmit a first PSCCH including a 1st-stage SCI over a sidelink from a Tx UE to a Rx UE, and transmit a PSSCH that is associated with the PSCCH and includes a 2nd-stage SCI encoded by polar code having CRC bits.

Aspects of the disclosure provide a non-transitory computer-readable medium storing instructions that, when executed by a processor, causing the processor to perform the method of sidelink transmission with two-stage SCI.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a wireless communication system 100 according to an embodiment of the disclosure.

FIG. 2 shows a resource pool 200 configured for sidelink communications according to an embodiment of the disclosure.

FIG. 3 shows a sidelink transmission 300 with a two-stage sidelink control information (SCI) according to an embodiment of the disclosure.

FIG. 4 shows another sidelink transmission 400 with a two-stage SCI according to an embodiment of the disclosure.

FIG. 5 shows a sidelink synchronization signal block (S-SSB) 500 according to an embodiment of the disclosure.

FIG. 6 shows S-SSB structures 601-604 over a 14-symbol slot.

FIG. 7 shows S-SSB structures 701-702 over a 14-symbol slot.

FIG. 8 shows S-SSB structures 801-807 over 12-symbols of a slot having 14 symbols.

FIG. 9 shows a process 900 of sidelink transmission with two-stage SCI according to an embodiment of the disclosure.

FIG. 10 shows a process 1000 of sidelink transmission with two-stage SCI according to an embodiment of the disclosure.

FIG. 11 shows an apparatus 1100 according to embodiments of the disclosure.

### DETAILED DESCRIPTION OF EMBODIMENTS

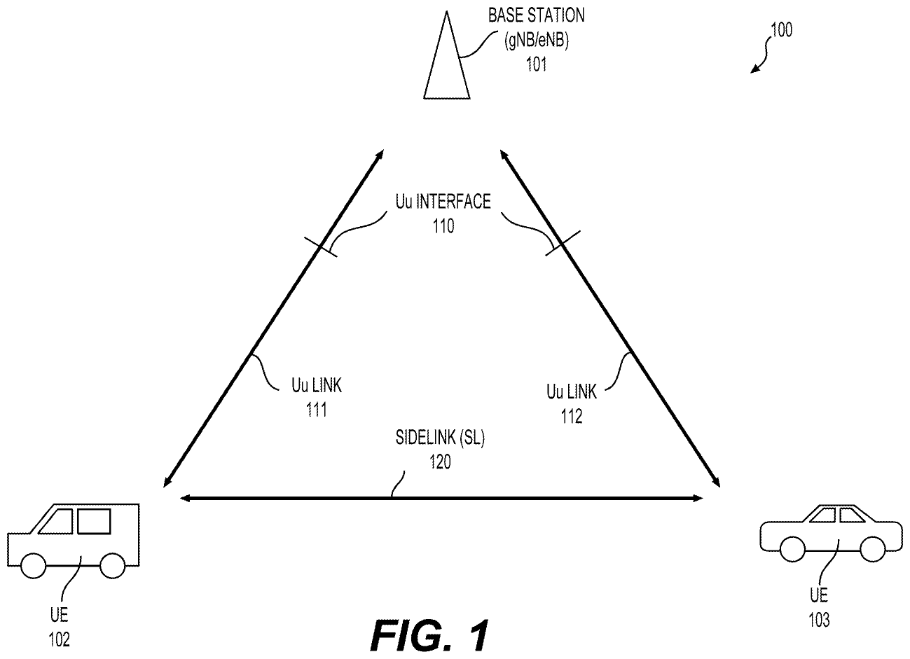

FIG. 1 shows a wireless communication system 100 according to an embodiment of the disclosure. The system 100 can include a base station (BS) 101, a first user equipment (UE) 102, and a second UE 103. The BS 101 can be an implementation of a gNB specified in the 3rd Generation Partnership Project (3GPP) New Radio (NR) standards, or can be an implementation of an eNB specified in 3GPP Long Term Evolution (LTE) standards. Accordingly, the BS 101 can communicate with the UE 102 or 103 via a radio air interface 110 (referred to as a Uu interface 110) according to respective wireless communication protocols. In other examples, the BS 101 may implement other types of standardized or non-standardized radio access technologies, and communicate with the UE 102 or 103 according to the respective radio access technologies. The UE 102 or 103 can be a vehicle, a computer, a mobile phone, a roadside unit, and the like.

The UEs 102 and 103 can communicate with each other based on vehicle-to-everything (V2X) technologies, for example, as specified in 3GPP standards. A direct radio link 120, referred to as a sidelink (SL), can be established between the UEs 102 and 103. The sidelink 120 can be either a sidelink from the UE 102 to the UE 103, or a sidelink from the UE 103 to the UE 102. The UE 102 can use a same spectrum for both uplink transmissions over a Uu link 111 and sidelink transmissions over the sidelink 120. Similarly, the UE 103 can use a same spectrum for both uplink transmissions over a Uu link 112 and SL transmissions over the sidelink 120. In addition, allocation of radio resources over the sidelink 120 can be controlled by the BS 101.

Different from the FIG. 1 example (in-coverage scenario) where the UEs 102 and 103 performing sidelink communications are under network coverage (the coverage of a cell of the BS 101), in other examples, UEs performing sidelink communications can be outside of network coverage. For example, a sidelink can be established between two UEs both of which are located outside of network coverage (out-of-coverage scenario), or one of which is located outside of network coverage (partial-coverage scenario).

In some examples, a group of UEs (such as the UEs 102 and 103 and other UEs (not shown)) in a local area may communicate with each other using sidelinks under or without control of abase station. Each UE in the group may periodically or aperiodically transmits messages to neighboring UEs. In addition, the respective transmissions can be of a type of unicast, groupcast, or broadcast. For example, hybrid automatic repeat request (HARQ) and link adaptation mechanisms can be employed to support unicast or groupcast between a transmission (Tx) UE and a reception UE(s).

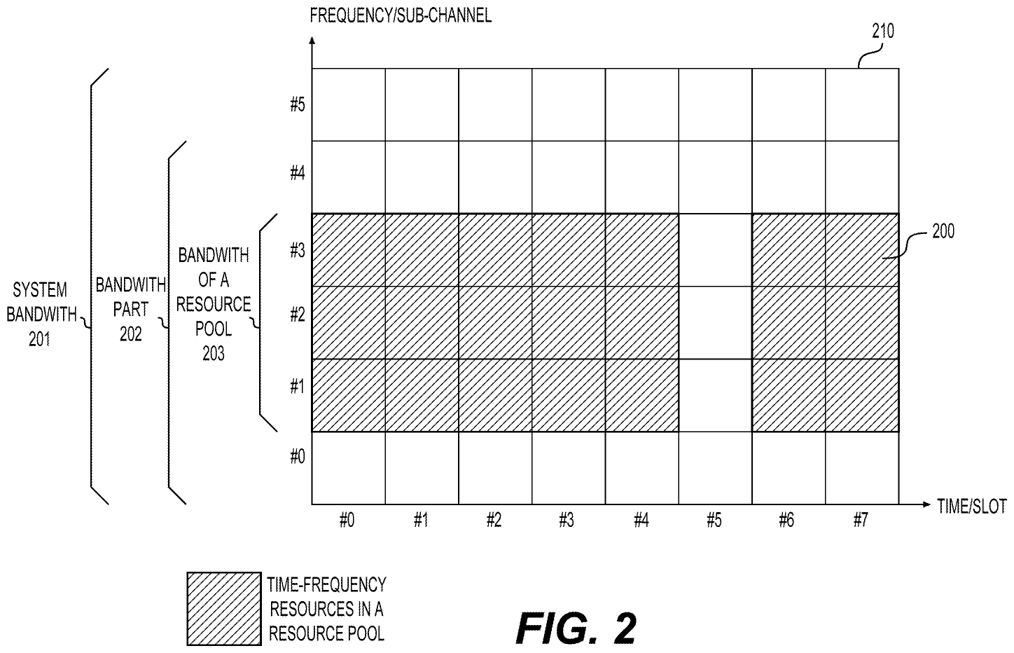

FIG. 2 shows an example of a resource pool 200 configured for sidelink communications according to an embodiment of the disclosure. For example, the resource pool 200 can be configured to the UE 102 from the BS 101, or can be pre-configured to the UE 102 (e.g., a resource pool configuration is stored in a universal integrated circuit card (UICC) of the UE 102). The resource pool 200 can be defined over a time-frequency (slot/sub-channel) resource grid 210. Radio resources for transmission of physical channels (e.g., physical sidelink control channel (PSCCH), physical sidelink shared channel (PSSCH), and the like) from the UE 102 on the sidelink 120 can be allocated based on the resource pool 200.

As shown, a system bandwidth 201 of the UE 102 can include sub-channels #0-#5. Each sub-channel may include a number of physical resource blocks (PRBs, or RBs) (e.g., 5, 10, or 20 PRBs). The resource pool 200 can include a set of consecutive (or non-consecutive) sub-channels #1-#3 in frequency domain. If the UE 102 operates in a bandwidth part (BWP) 202, a bandwidth 203 of the resource pool 200 can be configured to be within the BWP 202. In time domain, the resource pool 200 can include a number of slots (e.g., slots 40-#1 and #6-#7) that can be consecutive or non-consecutive in different examples.

Resource pools can be (pre-)configured to the UE 102 separately from the transmission perspective (Tx pools) and the reception perspective (Rx pools). Accordingly, the UE 102 can monitor for PSCCHs, and hence receive respective PSSCH transmissions from other UEs in a Rx pool while performing transmissions in a Tx pool.

In an embodiment, within each of the slots of the resource pool 200, there can be from 7 to 14 of the symbols reserved for sidelink operation, of which PSSCH can be transmitted in 5 to 12 symbols, respectively. The remaining sidelink symbols in each slot (not used for PSSCH transmission) can transmit physical sidelink feedback channel (PSFCH), automatic gain control (AGC) symbol(s), guard period (GP) symbol(s), or uplink or downlink symbols.

In an embodiment, two resource allocation modes (Mode 1 and Mode 2) can be used for allocating radio resources for PSCCH and PSSCH transmissions over a sidelink. In Mode 1, the BS 101 performs the function of resource scheduling. For example, the BS 101 can provide dynamic grants of sidelink resources, or semi-statically configured grants of periodic sidelink resources (referred to as sidelink configured grants) to the UE 102 for sidelink communications over the sidelink 120.

A dynamic sidelink grant can be provided in a downlink control information (DCI), and schedule resources for an initial transmission of a transport block, and optionally, retransmissions of the same transport block. The retransmissions can be blindly repeated transmissions, or can be retransmissions in response to a HARQ feedback. In one example, resources for each transmission or retransmission can be spanned over one or more sub-channels but limited within one slot in the sidelink resource pool 200.

For a sidelink configured grant, the scheduled resources can be a set of sidelink resources recurring with a periodicity to accommodate periodically transmitted messages. Two types of configured grant are defined in an example. The Type 1 configured grant can be configured once (e.g., by radio resource control (RRC) signaling) and used by the UE 102 immediately until being released by RRC signaling. The Type 2 configured grant can be configured once. Activation or deactivation signaling via a DC1 can be employed to start or terminate usage of the Type 2 configured grant. Multiple configured grants can be configured to allow provision for different services, traffic types, etc.

In an embodiment, modulation and coding scheme (MCS) information for dynamic and configured grants can optionally be provided or constrained by RRC signaling instead of traditional DCI. RRC can configure an exact MCS, or a range of MCS. In an example, RRC does not provide the exact MCS, a transmitting UE can select an appropriate MCS itself based on the knowledge of a transport block (113) to be transmitted and, potentially, sidelink radio conditions.

When the UE 102 is in an out-of-coverage status, or the UE 102 is in an in-coverage status but instructed by the BS 101, Mode 2 can be employed for resource scheduling (resource allocation). In Mode 2, the UE 102 can autonomously select resources for sidelink transmissions based on a sensing procedure. For example, the UE 102 can sense, within a (pre-) configured resource pool, which resources are not in use by other UEs with higher-priority traffic, and select an appropriate amount of resources for sidelink initial transmissions and, optionally, retransmissions. In the selected such resources, the UE 102 can transmit and re-transmit a certain number of times.

For example, the UE 102 can reserve resources to be used for a number of blind (re-)transmissions or HARQ-feedback-based (re-)transmissions of a transport block. The UE 102 can also reserve resources to be used for an initial transmission of a later transport block. The reserved resources can be indicated in an SCI scheduling a transmission of a transport block. Alternatively, an initial transmission of a transport block can be performed after sensing and resource selection, but without a reservation.

SCIs (e.g., 1st-stage SCI) transmitted by UEs on PSCCH indicate selected (or reserved) time-frequency resources in which the respective UE will transmit a PSSCH. (The indicated time-frequency resources can be allocated with either Mode 1 or Mode 2.) These SCI transmissions can be used by sensing UEs to maintain a record of which resources have been reserved by other UEs in the recent past. When a resource selection is triggered (e.g. by traffic arrival or a resource re-selection trigger), the UE 102 (while performing sensing) considers a sensing window which starts a (pre-)configured time in the past and finishes shortly before the trigger time. The sensing UE 102 also measures, for example, the PSSCH reference signal received power (RSRP) over selected or reserved resources in the slots of the sensing window. The measurements can indicates a level of interference which would be experienced if the sensing UE 102 were to transmit in the selected or reserved resources.

The sensing UE 102 can then select resources for transmission(s) or retransmission(s) from within a resource selection window. For example, the resource selection window starts after the trigger for transmission, and cannot be longer than a remaining latency budget of a to-be-transmitted transport block. Based on the SCIs from the other UEs and the measurements as described above, selected or reserved resources by the other UEs in the selection window with PSSCH-RSRP above a threshold are excluded from being candidates by the sensing UE 102. The threshold can be set according to priorities of the traffic (e.g., priorities associated with respective transport blocks) of the sensing UEs and the other transmitting UEs. Thus, a higher priority transmission from the sensing UE 102 can occupy resources which are reserved by a transmitting UE with sufficiently low PSSCH-RSRP and sufficiently lower-priority traffic.

In an example, from the set of resources in the selection window which have not been excluded, the sensing UE can identify a certain percentage (e.g., 20%) of the available resources within the window as candidate resources. The UE 102 may select from the candidate resources for a number of initial- or re-transmissions of the to-be-transmitted transport block, for example, in a random way.

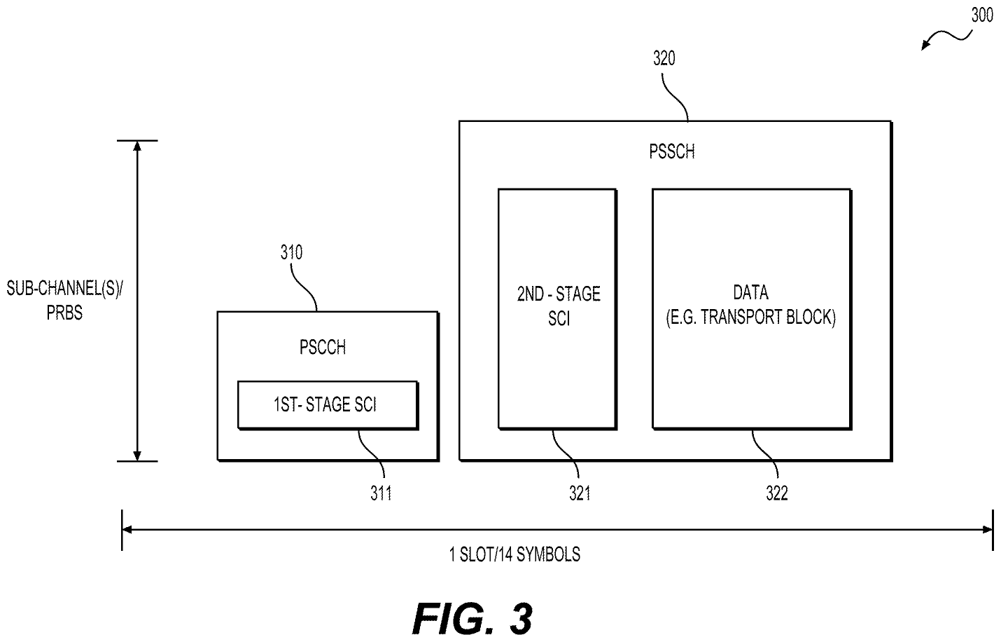

FIG. 3 shows an example of a sidelink transmission 300 with a two-stage SCI according to an embodiment of the disclosure. In the sidelink transmission 300, a PSCCH 310 and a PSSCH 320 associated with the PSCCH 310 can be generated and transmitted from the UE 102. The PSCCH 310 can carry a 1st-stage SCI 311, while the PSSCH 320 can carry a 2nd-stage SCI 321 and data 322 (e.g., data of a transport block and optionally other type of data). For example, the 1st-stage or 2nd-stage SCI can be generated and processed (e.g., channel coding, modulation, precoding, and the like) at a physical layer before being mapped to resource elements (REs) in the respective physical channels (e.g., PSCCH 310 or PSSCH 320). The transport block can be received from a higher layer (e.g., medium access control (MAC) layer) and processed (e.g., channel coding, modulation, precoding, and the like) at the physical layer before being mapped to REs in the respective PSSCH 320.

In one example, the UE 102 can be configured to perform each transmission or retransmission of a transport block or other type of data within a slot in time domain. Accordingly, as shown in FIG. 3, resources for transmitting PSCCH 310 and PSSCH 320 can be selected in a Tx resource pool within a slot in time domain and one or more sub-channels in frequency domain. In an example, a slot may include 14 symbols (e.g., orthogonal frequency division multiplexing (OFDM) symbols) but may have different duration depending on respective sub-carrier spacings. For example, corresponding to different sub-carrier spacings 15 kHz, 30 kHz, or 60 kHz, a 1-ms subframe may include 1, 2, or 4 slots each including 14 symbols.

In other examples, the PSCCH 310 and the PSSCH 320 may be transmitted in different slots. Accordingly, resources for transmitting PSCCH 310 and PSSCH 320 can be selected from different slots in a Tx resource pool.

In FIG. 3, the PSCCH 310 and the PSSCH 320 are shown to be time-division multiplexed (TDMed). However, in other examples, the PSCCH 310 and the PSSCH 320 can be frequency-division multiplexed (FDMed). For example, within the bandwidth of the assigned sub-channels in FIG. 3, the resources above the PSCCH 310 can also be assigned for transmission of the PSSCH 320.

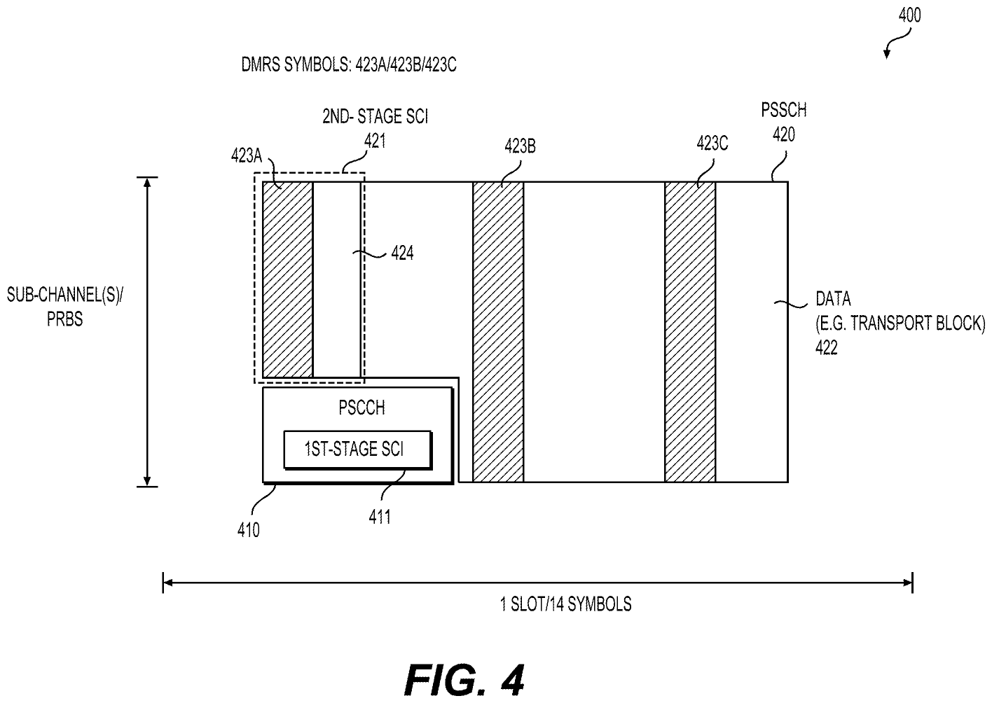

FIG. 4 shows another example of a sidelink transmission 400 with a two-stage SCI according to an embodiment of the disclosure. In the sidelink transmission 400, a PSCCH 410 and an associated PSSCH 420 can be generated and transmitted from the UE 102. The PSCCH 410 can carry a 1st-stage SCI 411, while the PSSCH 420 can carry a 2nd-stage SCI 421 and data 422 (e.g., data of a transport block). Similar to the FIG. 3 example, time-frequency resources for transmitting PSCCH 410 and the PSSCH 420 can be selected to be within a slot in time domain and one or more sub-channels in frequency domain in a Tx resource pool. Different from the FIG. 3 example, the PSSCH 420 is TDMed and FDMed with the PSCCH 410.

In addition, as shown in FIG. 4, the PSSCH 420 can be multiplexed with a demodulation reference signal (DMRS) mapped in several symbols 423A, 423B, and 423C (referred to as DMRS symbols). In an example, PRBs in the DMRS symbols can each include REs in which the DMRS is mapped. The REs carrying the DMRS in one DMRS symbol may form a comb-alike structure in some examples. REs without carrying the DMRS in one DMRS symbol can be used to carry the 2nd-stage SCI 421 or the data 422.

Two-stage SCI is used for sidelink transmission in the examples of FIG. 3 and FIG. 4. The corresponding sidelink transmissions 300 or 400 can be of a type of unicast, groupcast, or broadcast. During the transmissions 300/400, the 1st-stage SCI 311/411 can be employed for sensing purpose and carry information related to channel sensing. The 1st-stage SCI 311/411 can also carry information of resource allocation of the respective PSSCH 320/420.

The 2nd-stage SCI 321/421 can carry information (e.g., new data indicator, and redundancy version (RV)) needed for identifying and decoding the data 322/422, controlling HARQ procedures, triggering channel state information (CSI) feedback, and the like. The 2nd-stage SCI 321/421 can be transmitted with link adaptation based on channel conditions between the Tx UE 102 and the target UEs. For example, a high coding rate may be used for transmitting the 2nd-stage SCI 321/421 to improve spectra efficiency. The high coding rate can be determined based on a signal to noise ratio (SNR) level of channels between the Tx UE 102 and the target UEs. In an example, polar code is used for channel coding of the 2nd-stage SCI 321/421.

In an embodiment, a physical layer identity (L1-ID) is transmitted by scrambling a cyclic redundancy check (CRC) of a 2nd-stage SCI with the L1-ID. The L1-ID can be a source ID or a destination ID. All or a part of the L1-ID can be scrambled with the CRC of the 2nd-stage SCI. Compared with carrying the L1-ID as a payload of the 2nd-stage SCI, the method of scrambling bits of the L1-ID with CRC bits can reduce the size of the payload of the 2nd-stage SCI and reduce transmission overhead associated with the 2nd-stage SCI.

A CRC can be used for error detection in a 2nd-stage SCI. For example, a 2nd-stage SCI can have a payload of dozens of bits (e.g., 20 bits, 30 bits, or the like). The payload can be used to calculate a set of CRC bits (CRC parity bits). Various algorithms can be used for the calculation. In an example, the payload of the 2nd-stage SCI is divided by a cyclic generator polynomial to generate the CRC bits. For example, the CRC bits can have a length of 16 bits, 24 bits, or the like. The CRC bits are then appended at the end of the 2nd-stage SCI payload.

The L1-ID can be used in different types of sidelink communications (i.e., unicast, groupcast, or broadcast). A source ID can indicate a Tx UE performing the sidelink transmission in unicast, groupcast, or broadcast. A destination ID can indicate an individual Rx UE or a group of Rx UEs in unicast or groupcast, respectively. In various embodiment, a destination ID or a source ID can have a length of 8 bits or 16 bits.

In the embodiment, during a scrambling process, a bit-wise XOR operation can be performed between the CRC bits of the 2nd-stage SCI and bits of all or a part of the L1-ID to generate a scrambled CRC. When the number of the L1-ID bits is smaller than that of the CRC bits, a subset of the CRC bits can be selected for the scrambling. The selection can be performed in various ways and known at respective Tx UE or Rx UE. For example, the foremost, intermediate, or rearmost bits of the CRC bits can be selected. In an example, when a part of the L1-ID is scrambled with the CRC bits, the remaining bits of the L1-ID can be carried as part of the payload of the 2nd-stage SCI, or a 1st-stage SCI associated with the 2nd-stage SCI.

In an example, 1st-stage SCI (e.g., a field in the 1st-stage SCI) is used to dynamically indicate whether a CRC of an associated 2nd-stage SCI is scrambled with an L1-ID for transmission of the L1-ID. For example, if a 1st-stage SCI indicates a sidelink transmission uses the scrambling method in an associated 2nd-stage SCI, a Rx UE would correspondingly perform a descrambling operation with a set of L1-IDs known to the Rx UE for decoding the 2nd-stage SCI. When the number of the set of L1-IDs is high, the chance of generating a false alarm (incorrect detection of the 2nd-stage SCI) will be high. Accordingly, under certain scenarios, the scrambling operation can be disabled.

There can be various ways for determining when to enable or disable scrambling a 2nd-stage SCI CRC with an L1-ID. In an example, the scrambling operation can first be used at a Tx UE for sidelink transmissions. A Rx UE can feedback to a Tx UE when a false alarm rate for detecting 2nd-stage SCI is above a threshold. As a response, the Tx UE can stop the usage of the scrambling operation. In another example, controlled by a BS, the scrambling operation can be used at a subset of Tx UEs under the coverage of the BS. For example, the BS can configure that the scrambling operation is only used for unicast sidelink transmissions, or only a part of unicast sidelink transmissions are allowed to use the scrambling operation.

In an example, at a Tx UE, a 1st-stage SCI can include a 1-bit field to indicate whether an L1-ID is scrambled with CRC bits of a corresponding 2nd-stage SCI. A Rx UE can accordingly determines how to decode the 2nd-stage SCI after decoding the 1st-stage SCI.

In an example, instead of using a 1st-stage SCI to dynamically indicate usage of the scrambling operation, a (pre-)configuration is used to enable or disable the usage of scrambling an L1-ID with a 2nd-stage SCI. For example, an RRC message can be signaled to covey a configuration to indicate whether the scrambling operation can be used on sidelink transmissions over resources of a resource pool. The UEs receiving the configuration will understand whether the scrambling operation is employed or not over the resource pool, and accordingly perform transmission and reception of sidelink transmissions over the resource pool.

In the above examples, when the scrambling operation is not used, the L1-ID can be carried as a payload of a 2nd-stage SCI or a 1st-stage SCI for the respective sidelink transmissions.

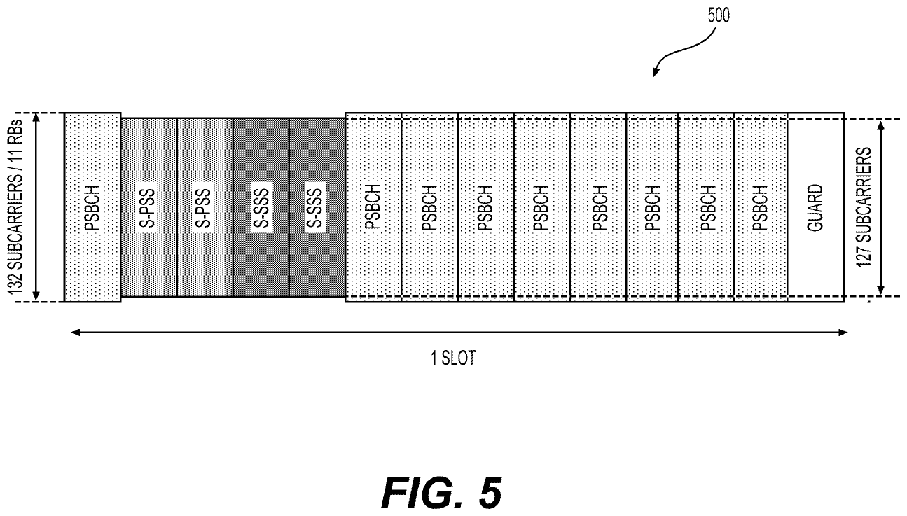

FIG. 5 shows a sidelink synchronization signal block (S-SSB) 500 according to an embodiment of the disclosure. The S-SSB 500 can be carried in a slot having 14 symbols. The S-SSB 500 can include two symbols of repeated sidelink primary synchronization signal (S-PSS) at the second and third symbols of the slot, and two symbols of repeated sidelink secondary synchronization signal (S-SSS) at the fourth and fifth symbols of the slot. The S-SSB 500 can further include a physical sidelink broadcast channel (PSBCH) and a DMRS multiplexed with the PSBCH in the remaining symbols (except a GP symbol at the end of the slot). The PSBCH can occupy 132 subcarriers (11 RBs) forming an S-SSB bandwidth, while the S-PSS and S-SSS can each occupy 127 subcarriers of the S-SSB bandwidth.

The S-PSS and S-SSS can use the same types of sequence as NR PSS and SSS for downlink of the Uu interface, respectively, i.e. an M-sequence and a Gold sequence. In an example, the S-PSS sequence can be generated use the same characteristic polynomial (e.g., x⁷+x⁴+1) as the NR PSS but with different cyclic shifts (e.g., 22 or 65).

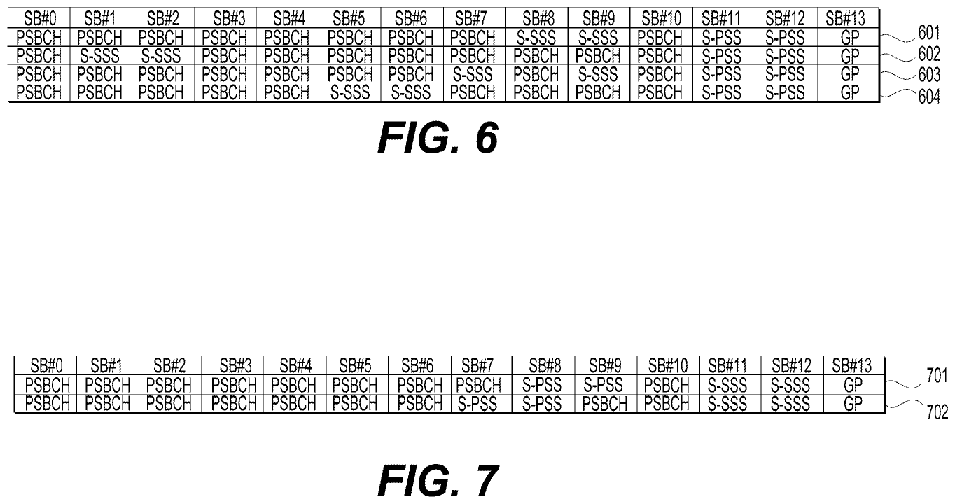

FIGS. 6-8 show different S-SSB structures according to embodiments of the disclosure.

FIG. 6 shows S-SSB structures 601-604 over a 14-symbol slot. Each S-SSB structure 601-604 can include an S-SSB over the symbols indexed from #0 to #12 and a GP symbol with an index of #13. Each S-SSB can include two consecutive S-PSS symbols at the end of the respective S-SSB, two consecutive or non-consecutive S-SSS symbols prior to the two S-PSS symbols with zero, one, or more PSBCH symbols in between.

In FIG. 6 example, the S-PSS, S-SSS and PSBCH may have different transmission power, and transient periods may be applied to maximize an overall SSB performance. For example, the S-PSS and S-SSS can use M-sequence and Gold sequence, respectively. Accordingly, the S-SSS can have a higher peak to average power ratio (PAPR) than the S-PSS. The S-SSB structures 601-604 can use the cyclic prefix-orthogonal frequency division multiplexing (CP-OFDM) waveform for transmission. Accordingly, the PSBCH in FIG. 6 can have a PAPR close to that of the S-SSS.

Due to the different PAPRs, the S-SSS and the PSBCH can have a similar power whereas the S-PSS can have a higher power. So, it is preferred that the two consecutive S-PSS symbols are arranged at the end of each slot followed by the GP symbol. In this way, only one power transition takes place between the symbol 410 and the symbol 411. In contrast, in the FIG. 5 example, the two S-PSS symbols arranged at the second and third symbols in the slot can incur two power transitions at the beginning or end of the two S-PSS symbols.

The S-SSS symbols can be located one or two symbols ahead of the S-PSS symbols for potential S-SSS channel estimation assisted by the S-PSS. Alternatively, the SSS symbols can be located at the center (or around the center) of the PSBCH symbols. The two parts of the PSBCH symbols separated by the S-SSS symbols can be repeated transmissions of a PSBCH so that a Rx UE may determine an early termination for PSBCH reception/decoding. The S-SSS can be used to help the channel estimation of PSBCH.

For the power transition between the symbols #10 and #11, a transient period can be applied at the beginning of the first S-PSS symbol. Alternatively, the transient period can be applied with one half period at the end of the PSBCH symbol (next to S-PSS) and the other half period at the beginning of the S-PSS symbol. Or, the transient period can be fully applied at the end of the PSBCH symbol (next to S-PSS) without any impact on the S-PSS symbols.

FIG. 7 shows S-SSB structures 701-702 over a 14-symbol slot. Each S-SSB structure 701-702 can include an S-SSB over the symbols from #0 to #12 and a GP symbol with an index of #13. Each S-SSB can include two consecutive S-SSS symbols at the end of the respective S-SSB, two consecutive or non-consecutive S-PSS symbols prior to the two S-SSS symbols with zero, one, or more PSBCH symbols in between.

In FIG. 7 example, the S-SSB structures 701-702 can use the discrete Fourier transform spread-orthogonal frequency division multiplexing (DFTS-OFDM) waveform for transmission. Accordingly, the S-PSS and the PSBCH can have a similar power whereas the S-SSS can have a less power due to the different PAPRs. Then, it is preferred that two consecutive S-SSS symbols are mapped to the end of the slot followed by the GP symbol. The S-PSS symbols can be located ahead of the S-SSS symbols with a few symbols of PSBCH (more than 1 symbol) in between to avoid confusion with NR Uu SSS.

A transient period can be applied in the beginning of the first S-SSS symbol. Alternatively, the transient period can applied with one half period at the end of the PSBCH symbol (next to S-SSS) and the other half period at the beginning of the S-SSS symbol. Or, the transient period can be fully applied to the end of the PSBCH symbol (next to S-SSS) without any impact on the S-SSS symbols.

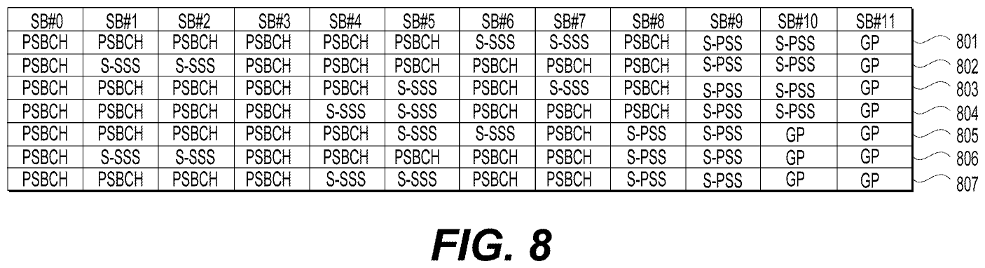

FIG. 8 shows S-SSB structures 801-807 over 12-symbols of a slot having 14 symbols. Depending on subcarrier spacing and/or cyclic prefix (CP) length, the total symbols of an S-SSB can be different. For example, S-SSBs of the S-SSB structures 801-804 can have 11 symbols: 2 S-PSS symbols, 2 S-SSS symbols, and 7 PSBCH symbols. S-SSBs of the S-SSB structures 805-807 can have 10 symbols: 2 S-PSS symbols, 2 S-SSS symbols, and 6 PSBCH symbols. The remaining symbols in each slot (including two last symbols not shown in FIG. 8) can be used as GP symbols or symbols for PSFCH transmission or Uu interface uplink or downlink transmission.

Although the S-SSB structures 801-807 are subcarrier and/or CP specific designs, the mapping rule of the S-PSS, S-SSS, and PSBCH can be similar to that of the FIG. 6 or FIG. 7 example. For example, similar to the FIG. 6 example, the S-PSS symbol can be arranged at the end of the slot (excluding GP symbol(s) and/or other reserved REs). Then, the two consecutive or non-consecutive S-SSS symbols can be located ahead of the S-PSS with zero, one or multiple symbols of PSBCH in between.

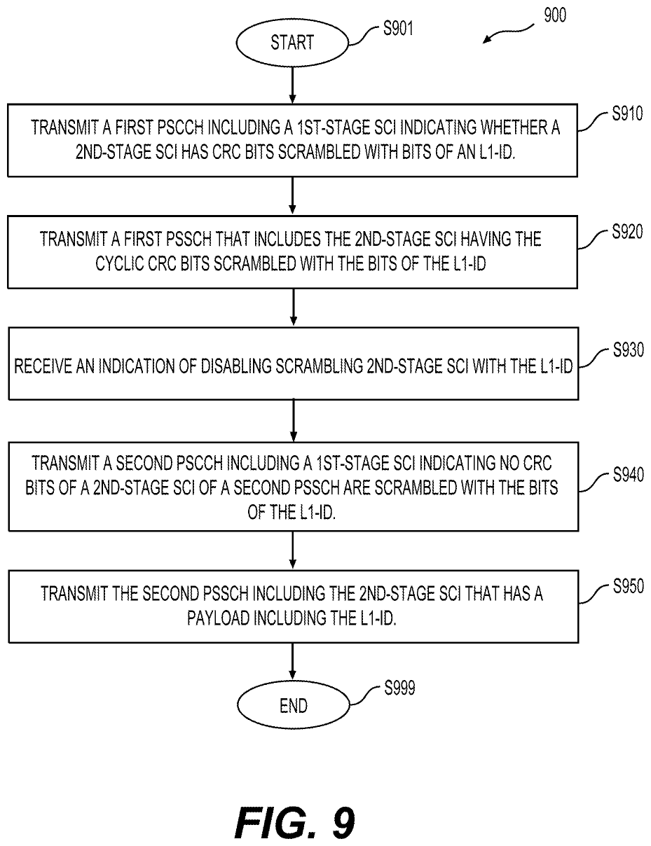

FIG. 9 shows a process 900 of sidelink transmission with two-stage SCI according to an embodiment of the disclosure. The process 900 can be performed by a Tx UE communicating with a Rx UE over a sidelink. The process 900 can start from S901, and proceed to S910. In various embodiments, some of the steps of the process 900 shown can be performed concurrently or in a different order than shown, can be substituted by other method steps, or can be omitted. Additional method steps can also be performed as desired. Aspects of the process 900 can be implemented by a wireless device, such as the UE 102 or 103 illustrated in and described with respect to the preceding figures.

At S910, a first PSCCH including a 1st-stage SCI can be transmitted over the sidelink from the Tx UE to the Rx UE. The 1st-stage SCI of the first PSCCH can indicate whether a 2nd-stage SCI of a first PSSCH associated with the PSCCH has CRC bits that are scrambled with bits of an L1-ED. The L1-ID can be a source ID or a destination ID corresponding to the transmission of the first PSCCH and the first PSSCH. A part of the L1-ID can be carried in a payload of the 2nd-stage SCI of the first PSSCH in some examples.

At S920, the first PSSCH associated with the first PSCCH and including the 2nd-stage SCI can be transmitted. At the Rx UE, based on the indication of the 1st-stage SCI, the Rx UE can accordingly decode the 2nd-stage SCI. For example, the Rx UE can perform descrambling operations to the CRC portion of the decoded 2nd-stage SCI using a set of L1-IDs known to the Rx UE.

At S930, an indication of disabling scrambling 2nd-stage SCI with the L1-ID can be received, for example, from a serving BS or the Rx UE. For example, when a density of UEs having sidelink communications with the Rx UE is high, false alarms resulting from descrambling operations at the Rx UE can be high. Accordingly, the Rx UE or the serving BS of the UE may determine to stop or reduce a number of Tx UEs currently performing the scrambling operations.

At S940, in response to the indication received at S930, a second PSCCH can be transmitted over the sidelink from the Tx UE to the Rx UE. The second PSCCH can include a 1st-stage SCI indicating no CRC bits of a 2nd-stage SCI of a second PSSCH associated with the second PSCCH are scrambled with the L1-ID.

At S950, the second PSSCH is transmitted. The 2nd-stage SCI of the second PSSCH is not scrambled with the L1-ID, and instead has a payload including the L1-1D. The process 900 can proceed to S999, and terminate at S999. It is noted that in other examples, the 1st-stage SCI of the PSCCH does not indicate whether the 2nd-stage SCI of the PSSCH has the CRC bits scrambled with the L1-ID. In some examples, S930-S950 can be omitted.

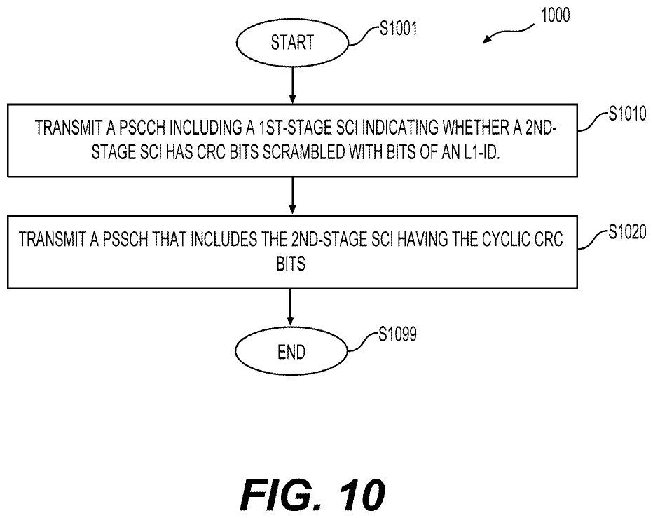

FIG. 10 shows a process 1000 of sidelink transmission with two-stage SCI according to an embodiment of the disclosure. The process 1000 can be performed by a Tx UE communicating with a Rx UE over a sidelink. The process 1000 can start from S1001, and proceed to S1010. In various embodiments, some of the steps of the process 1000 shown can be performed concurrently or in a different order than what is shown, can be substituted by other method steps, or can be omitted. Additional method steps can also be performed as desired. Aspects of the process 1000 can be implemented by a wireless device, such as the UE 102 or 103 illustrated in and described with respect to the preceding figures.

At S1010, a PSCCH including a 1st-stage SCI can be transmitted over the sidelink from the Tx UE to the Rx UE. In one embodiment, the 1st-stage SCI of the PSCCH can indicate whether a 2nd-stage SCI of a PSSCH associated with the first PSCCH has CRC bits that are scrambled with bits of an L1-ID. When the 1st-stage SCI of the PSCCH indicates the CRC bits of the 2nd-stage SCI of the PSSCH are not scrambled with the bits of the L1-ID, the PSSCH may include the 2nd-stage SCI that has a payload including the L1-ID. The L1-ID can be a source ID or a destination ID corresponding to the transmission of the first PSCCH and the first PSSCH. A part of the L1-ID can be carried in a payload of the 2nd-stage SCI of the first PSSCH in some examples. In some embodiments, the PSCCH is mapped to physical resources in one subchannel, and the PSSCH is mapped to physical resources in one or more subchannels.

At S1020, the PSSCH associated with the PSCCH and including the 2nd-stage SCI can be transmitted. The 2nd-stage SCI includes CRC bits and is encoded by polar code. At the Rx UE, based on the indication of the 1st-stage SCI, the Rx UE can accordingly decode the 2nd-stage SCI. For example, the Rx UE can perform descrambling operations to the CRC portion of the decoded 2nd-stage SCI using a set of L1-IDs known to the Rx UE. The process 1000 can proceed to S1099, and terminate at S1099.

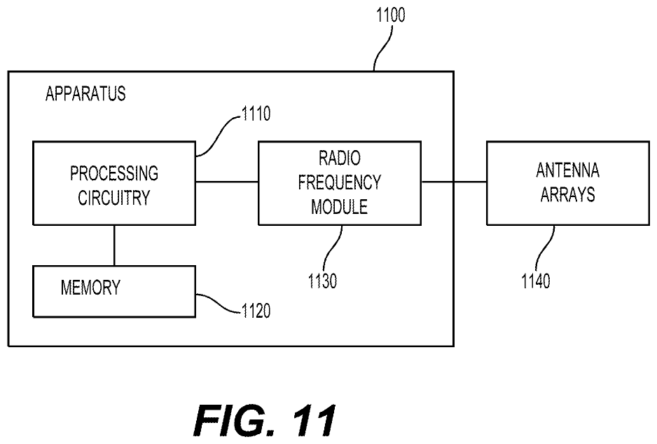

FIG. 11 shows an exemplary apparatus 1100 according to embodiments of the disclosure. The apparatus 1100 can be configured to perform various functions in accordance with one or more embodiments or examples described herein. Thus, the apparatus 1100 can provide means for implementation of mechanisms, techniques, processes, functions, components, systems described herein. For example, the apparatus 1100 can be used to implement functions of UEs or BSs in various embodiments and examples described herein. The apparatus 1100 can include a general purpose processor or specially designed circuits to implement various functions, components, or processes described herein in various embodiments. The apparatus 1100 can include processing circuitry 1110, a memory 1120, and a radio frequency (RF) module 1130.

In various examples, the processing circuitry 1110 can include circuitry configured to perform the functions and processes described herein in combination with software or without software. In various examples, the processing circuitry 1110 can be a digital signal processor (DSP), an application specific integrated circuit (ASIC), programmable logic devices (PLDs), field programmable gate arrays (FPGAs), digitally enhanced circuits, or comparable device or a combination thereof.

In some other examples, the processing circuitry 1110 can be a central processing unit (CPU) configured to execute program instructions to perform various functions and processes described herein. Accordingly, the memory 1120 can be configured to store program instructions. The processing circuitry 1110, when executing the program instructions, can perform the functions and processes. The memory 1120 can further store other programs or data, such as operating systems, application programs, and the like. The memory 1120 can include non-transitory storage media, such as a read only memory (ROM), a random access memory (RAM), a flash memory, a solid state memory, a hard disk drive, an optical disk drive, and the like.

In an embodiment, the RF module 1130 receives a processed data signal from the processing circuitry 1110 and converts the data signal to beamforming wireless signals that are then transmitted via antenna arrays 1140, or vice versa. The RF module 1130 can include a digital to analog converter (DAC), an analog to digital converter (ADC), a frequency up converter, a frequency down converter, filters and amplifiers for reception and transmission operations. The RF module 1130 can include multi-antenna circuitry for beamforming operations. For example, the multi-antenna circuitry can include an uplink spatial filter circuit, and a downlink spatial filter circuit for shifting analog signal phases or scaling analog signal amplitudes. The antenna arrays 1140 can include one or more antenna arrays.

The apparatus 1100 can optionally include other components, such as input and output devices, additional or signal processing circuitry, and the like. Accordingly, the apparatus 1100 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method, comprising:
transmitting a physical sidelink control channel (PSCCH) including a 1st-stage sidelink control information (SCI) over a sidelink from a transmission user equipment (Tx UE) to a reception user equipment (Rx UE); and
transmitting a physical sidelink shared channel (PSSCH) that is associated with the PSCCH and includes a 2nd-stage SCI encoded by polar code having cyclic redundancy check (CRC) bits.

2. The method of claim 1, wherein the 1st-stage SCI of the PSCCH indicates whether the 2nd-stage SCI of the PSSCH has the CRC bits scrambled with bits of a physical layer identity (L1-ID).

3. The method of claim 2, wherein the transmitting includes:
transmitting the PSSCH including the 2nd-stage SCI that has a payload including the L1-ID when the 1st-stage SCI of the PSCCH indicates no CRC bits of the 2nd-stage SCI of the PSSCH are scrambled with the bits of the L1-ID.

4. The method of claim 2, further comprising:
receiving a configuration indicating whether to carry information of the L1-ID by scrambling the CRC bits of the 2nd-stage SCI with the bits of the L1-ID.

5. The method of claim 2, wherein the L1-ID is a source ID or a destination ID corresponding to the transmission of the PSCCH and the PSSCH.

6. The method of claim 2, wherein a part of the L1-ID is carried in a payload of the 2nd-stage SCI of the PSSCH.

7. The method of claim 1, wherein the PSCCH is mapped to physical resources in one subchannel, and the PSSCH is mapped to physical resources in one or more subchannels.

8. The method of claim 1, further comprising:
transmitting a sidelink synchronization signal block (S-SSB) in a slot, where the S-SSB includes two consecutive sidelink primary synchronization signal (S-PSS) symbols at the end of the S-SSB followed by one or more guard period (GP) symbols in the slot.

9. The method of claim 8, wherein the S-SSB includes two sidelink secondary synchronization signal (S-SSS) symbols arranged ahead of the two consecutive S-PSS symbols with zero, one, or more than one physical sidelink broadcast channel (PSBCH) symbols between the two S-SSS symbols and the two consecutive S-PSS symbols.

10. An apparatus, comprising circuitry configured to:
transmit a physical sidelink control channel (PSCCH) including a 1st-stage sidelink control information (SCI) over a sidelink from a transmission user equipment (Tx UE) to a reception user equipment (Rx UE); and
transmit a physical sidelink shared channel (PSSCH) that is associated with the PSCCH and includes a 2nd-stage SCI encoded by polar code having cyclic redundancy check (CRC) bits.

11. The apparatus of claim 10, wherein the 1st-stage SCI of the PSCCH indicates whether the 2nd-stage SCI of the PSSCH has the CRC bits scrambled with bits of a physical layer identity (L1-ID).

12. The apparatus of claim 11, wherein the circuitry is further configured to:
transmit the PSSCH including the 2nd-stage SCI that has a payload including the L1-ID when the 1st-stage SCI of the PSCCH indicates no CRC bits of the 2nd-stage SCI of the PSSCH are scrambled with the bits of the L1-ID.

13. The apparatus of claim 11, wherein the circuitry is further configured to:
receive a configuration indicating whether to carry information of the L1-ID by scrambling the CRC bits of the 2nd-stage SCI with the bits of the L1-ID.

14. The apparatus of claim 11, wherein the L1-ID is a source ID or a destination ID corresponding to the transmission of the PSCCH and the PSSCH.

15. The apparatus of claim 11, wherein a part of the L1-ID is carried in a payload of the 2nd-stage SCI of the PSSCH.

16. The apparatus of claim 11, wherein the PSCCH is mapped to physical resources in one subchannel, and the PSSCH is mapped to physical resources in one or more subchannels.

17. The apparatus of claim 10, wherein the circuitry is further configured to:
transmit a sidelink synchronization signal block (S-SSB) in a slot, where the S-SSB includes two consecutive sidelink primary synchronization signal (S-PSS) symbols at the end of the S-SSB followed by one or more guard period (GP) symbols in the slot.

18. The apparatus of claim 17, wherein the S-SSB includes two sidelink secondary synchronization signal (S-SSS) symbols arranged ahead of the two consecutive S-PSS symbols with zero, one, or more than one physical sidelink broadcast channel (PSBCH) symbols between the two S-SSS symbols and the two consecutive S-PSS symbols.

19. A non-transitory computer-readable medium storing instructions that, when executed by a processor, causing the processor to perform a method, the method comprising:
transmitting a physical sidelink control channel (PSCCH) including a 1st-stage sidelink control information (SCI) over a sidelink from a transmission user equipment (Tx UE) to a reception user equipment (Rx UE); and
transmitting a physical sidelink shared channel (PSSCH) that is associated with the PSCCH and includes a 2nd-stage SCI encoded by polar code having cyclic redundancy check (CRC) bits.

20. The non-transitory computer-readable medium of claim 19, wherein the 1st-stage SCI of the PSCCH indicates whether the 2nd-stage SCI of the PSSCH has the CRC bits scrambled with bits of a physical layer identity (L1-ID).
